(19) United States
(12) Patent Application Publication
(10) Pub. No.: US 2003/0138623 A1
(43) Pub. Date: Jul. 24, 2003

(54) Adhesive film tape with reduced halogen content

(75) Inventor: Bernhard Mussig, Seevetal (DE)

Correspondence Address: KURT BRISCOE, NORRIS, MCLAUGHLIN & MARCUS, P.A., 220 EAST 42ND STREET, 30TH FLOOR, NEW YORK, NY, 10017, US

(73) Assignee: tesa Aktiengesellschaft

(21) Appl. No.: 10/227,013

(22) Filed: Aug. 23, 2002

(30) Foreign Application Priority Data
Jan. 18, 2002 (DE) 102 02 038.8

(51) Int. Cl. B32B 1/00

(52) U.S. Cl. 428/337; 156/53; 428/343

(57) ABSTRACT

An adhesive tape for insulating and winding wires or cables, having a carrier material which is coated on one or both sides with an adhesive, wherein said carrier material is composed of a preferably stretched PVC film in web form having a thickness of up to 40 μm, preferably from 20 to 40 μm, and is substantially plasticizer-free.

The present invention relates to an adhesive tape for insulating and winding wires or cables, with a carrier material coated on one or both sides with an adhesive, and to its use as an insulating tape or tape for wrapping and bundling wires and cables, especially in vehicles such as automobiles.

Adhesive insulating and cable wrapping tapes are normally composed of plasticized PVC film with a coating of adhesive on one side.

There exists an increasing desire to remove disadvantages of these products. These disadvantages are outgassing of plasticizers and high halogen content.

The plasticizers in conventional adhesive insulating tapes and adhesive cable wrapping tapes give off vapor, leading to a health hazard; the commonly used DOP, in particular, is objectionable. Moreover, the vapors deposit on the glass in motor vehicles, impairing visibility, which is known to the skilled worker as fogging (DIN 75201). With even greater evaporation as a result of relatively high temperatures, in the engine compartment of vehicles, for example, or in electrical equipment in the case of insulating tapes, the resulting loss of plasticizer causes embrittlement of the adhesive tape.

Plasticizers impair the fire behavior of unadditived PVCs, which is compensated in part by adding antimony compounds, which are highly toxic, and which can also be improved somewhat by using chlorine or phosphorus plasticizers

Against the background of the debate concerning incineration of plastic wastes, such as shredder waste from vehicle recycling, for example, there exists a trend toward reducing the halogen content. In the case of cable insulation, therefore, the wall thicknesses are being reduced, and attempts are being made to reduce the thickness of the PVC film in adhesive tapes used for wrapping. The customary thickness is from 100 to 200 μm. At from 70 to 85 μm, considerable problems arise in the calendering process, with the consequence that virtually no such products are on the market.

The customary adhesive tapes comprise stabilizers based on toxic heavy metals, usually lead, more rarely cadmium or barium.

Attempts are being made to use wovens or nonwovens instead of plasticized PVC film; however, the products resulting from such attempts are but little used in practice, since they are relatively expensive and differ sharply from the habitual products in handling (hand tearability) and under service conditions (resistance to service fluids, electrical properties).

In modern-day vehicle construction, on the one hand the cable harnesses are becoming more and more bulky and thick as a result of the multiplicity of electrical consumer units and the increased transfer of information within vehicles, while on the other hand the space for installation is becoming ever more greatly restricted and, consequently, the guidethrough possibilities when laying cables within the body are becoming more problematic. Consequently, a relatively thin tape which, like the tape of the invention, also has a relatively low coefficient of sliding friction is an advantage. Moreover, for efficient and cost-effective cable harness production, cable wrapping tapes are expected to have easy and quick processing qualities.

Adhesive tapes based on plasticized PVC film are used in automobiles for bandaging electrical lines to form cable harnesses. Although initially the prime purpose was to improve the electrical insulation when using these adhesive tapes, which were originally developed as insulating tapes, adhesive cable harness tapes are now required to fulfil further functions, such as the bundling and permanent fixing of a plurality of the individual cables to form a stable cable strand and to protect the individual cables against mechanical, thermal, and chemical attack.

Manual separation from the roll of conventional adhesive PVC film tape leads easily to overstretching of the PVC film and to a corrugated torn edge, which makes secure end bonding more difficult. In the case of shrinkback, the overstretch may result in detachment of the bonded end (a problem known to the skilled worker as flagging).

DE 199 10 730 A1 describes a laminate carrier which is composed of velour or foam and a nonwoven, which are bonded to one another adhesively by means of a double-sided adhesive tape or with a hotmelt adhesive.

EP 0 886 357 A2 describes a triple-ply protective wrapping comprising a spunbonded web, a PET knit, and a strip of foam or felt, which are laminated to one another, the protective wrapping additionally being provided at least in part, and very complicatedly, with adhesive strips and touch-and-close fastener systems.

EP 1 000 992 A1 describes a holed cotton nonwoven which has a polyethylene coating from 10 to 45 μm thick and also an additional release coating.

DE-U 94 01 037 describes an adhesive tape having a tapelike textile carrier composed of a stitchbonded web formed in turn from a large number of sewn-in stitches which run parallel to one another. The web proposed there is said to have a thickness of from 150 to 400 μm for a basis weight of from 50 to 200 g/m².

DE 44 42 092 C1 describes an adhesive tape based on stitchbonded web which is coated on the reverse of the carrier. DE 44 42 093 C1 is based on the use of a web as a carrier for an adhesive tape, said web being a cross-laid fiber web which is reinforced by the formation of loops from the fibers of the web, i.e., a web known to the skilled worker under the name Malifleece. DE 44 42 507 C1 discloses an adhesive tape for cable bandaging, but bases it on what are known as Kunit or Multiknit webs. All three documents used webs having a basis weight of approximately 100 g/m², as can be inferred from the examples.

DE 195 23 494 C1 discloses the use of an adhesive tape with a nonwoven material carrier having a thickness of from 400 to 600 μm for bandaging cable harnesses, coated on one side with an adhesive.

DE 199 23 399 A1 discloses an adhesive tape having a tapelike backing of nonwoven material, which is coated on at least one side with an adhesive, the nonwoven web being a staple fiber web which is consolidated mechanically or wet-laid. Between 2% and 50% of the fibers of the web are fusible fibers, consisting more specifically of homopolymer, copolymer or bicomponent fibers with a relatively low softening or melting point.

It is mentioned by way of example that the fusible fibers of the web are composed of polypropylene, polyethylene, polyamide, polyester or copolymers.

The web disclosed is said to have the following properties:

a web weight of from 60 to 400 g/m², especially 200 g/m²

a web thickness of from 100 to 3000 μm, in particular from 500 to 1000 μm.

A further adhesive tape with a tapelike backing of nonwoven material is disclosed in DE 199 37 446 A1. The adhesive tape is coated on at least one side with an adhesive, the nonwoven web being a staple fiber web which is preconsolidated mechanically or wet-laid. Here, the further consolidation of the staple fiber web takes place by the addition of binders, such as powders, films, meshes or binding fibers, for example. The binders may have been dissolved in water or organic solvents and/or may be in the form of a dispersion.

The binders are preferably employed in the form of a binding dispersion such as elastomers or such as thermosets in the form of phenolic or melamine resin dispersions, as dispersions of natural or synthetic rubbers or as dispersions of thermoplastics such as acrylates, vinyl acetates, polyurethanes, styrene-butadiene systems, PVC, and also copolymers thereof.

The web disclosed is said to have the following properties:

a web weight of from 50 to 500 g/m², in particular from 80 to 200 g/m²

a web thickness of from 100 to 3000 μm, in particular from 200 to 1000 μm.

WO 99/24518 A1 describes an adhesive tape wherein the carrier material is a nonwoven web which becomes suitable for use for adhesive tapes only by the specific selection of fibers or filaments having a linear density of more than 15 denier and also by an additional film layer which is extruded on.

The only webs able to meet the objectives set therein are those exhibiting a basis weight of from 34 to 678 g/m².

DE 197 32 958 A1 discloses an adhesive tape for wrapping elongate products, such as cable harnesses or plastic sections, which has a tapelike backing bounded by two lateral edges and provided on at least one side with a self-adhesive layer of a pressure sensitive adhesive (PSA). The chemical composition of the PSA is such that, under gentle applied pressure on two adhesive layers lying one above the other, the interfaces are dissolved and the adhesive film layers coalesce completely to form a homogeneous PSA mass.

The invention depicted here also embraces a method of wrapping the elongate product. According to that method, the elongate product is positioned lengthways, in the region of a section of the adhesive tape, on a side of a tapelike backing of the adhesive tape that is provided with a self-adhesive layer, and then the adhesive tape is bonded in such a way that at least two adhesive regions of the tapelike backing are stuck to one another on the side provided with the adhesive layer in such a way that interfaces of the adhesive layer dissolve to form a homogeneous mass.

The result is therefore a pennant which protrudes from the wrapped product and which, especially under the restricted space conditions in automobile construction, is highly undesirable and harbors the potential risk that, when the cable harness is drawn through restricted apertures or passages, in the bodywork for example, the wrap will remain hanging and tear off, or at least the covering will be damaged. This is to avoided.

Moreover, it is stressed continually that the only webs suitable are those with a basis weight of more than 100 g/m².

Webs with this kind of thickness, such as are mentioned comprehensively in the state of the art, make the cable harnesses even thicker and more inflexible than conventional PVC tapes, albeit with a positive effect on soundproofing, which in some areas of cable harnesses is an advantage.

It is an object of the invention to provide an adhesive tape having a PVC-based carrier material which enables wires and cables to be bundled or insulated simply, inexpensively, and rapidly, so that the disadvantages of the prior art do not occur or at least not to the same extent while at the same time avoiding plasticizers and achieving a significant reduction in the halogen content of the adhesive tape per m², which is of extraordinary significance for the recovery of heat energy from wastes including such tapes (for example, incineration of the plastics fraction from vehicle recycling).

This object is achieved by means of an adhesive tape as specified in the main claim. The subclaims relate to advantageous developments of the adhesive tape and to preferred applications of the adhesive tape of the invention.

The invention accordingly provides an adhesive tape for insulating and winding Wires or cables, having a carrier material which is coated on one or both sides with an adhesive, said carrier material being composed of a preferably stretched PVC film in web form having a thickness of up to 40 μm, preferably from 20 to 40 μm, and is substantially plasticizer-free.

In the case of embossed film, the thickness before embossing is taken as the basis.

In a first advantageous embodiment of the adhesive tape, the PVC film has

a thickness of from 25 to 30 μm and/or

a K value of from 60 to 90, preferably from 75 to 80.

With further preference the PVC film is embossed, the depth of the embossing being preferably from 10 to 30 μm and/or the embossing comprising a pattern with continuous or interrupted lines extending longitudinally or transversely.

With further preference, the PVC film is stabilized with at least 0.7 phr of a tin compound.

The adhesive tape of the invention is substantially free from plasticizers and therefore has excellent fire behavior and low emissions (outgassing of plasticizer).

The usefulness of an adhesive tape of this kind comprising a stretched and plasticizer-free PVC film is surprising to the skilled worker and could not have been foreseen. Films of this kind are known for packaging applications (for example, for sliced cheese) and in that application usually have thicknesses of from 30 to 90 μm. They are prepared by stretching the relatively thick primary film in the machine direction (md) or, preferably, biaxially (KOBRA™ process) to the desired thickness.

For the adhesive tape of the invention the range from 20 to 40 μm is of interest, since the halogen content of the adhesive tape depends essentially on the thickness of the PVC film. Using such low thicknesses, there is a drastic reduction not only in the hitherto customary halogen (chlorine) content of the adhesive tape but also in the weight, which is particularly significant in vehicles. The weight per unit area of the adhesive tape of the invention is generally below 80 g/m², preferably below 65 g/m².

Moreover, the production costs for the adhesive tapes of the invention are also more attractive. Taking into account the processing properties during production and coating of the film and the processing properties of the adhesive tape (rigidity, hand tearability), the optimum thickness range for the carrier film is from 25 to 30 μm.

The film is substantially free from plasticizers such as DOP or TOTM, for example, since plasticized and simultaneously stretched films lead to adhesive tape rolls which are not stable on storage; they telescope, as the skilled worker would say. Astonishingly, this telescoping occurs hardly at all when the stretched film used is plasticizer-free. Even without plasticizers, surprisingly, the adhesive tape is sufficiently conformable for application, provided the stated thickness range is observed. Although the force at 10% elongation is markedly higher than in the case of the standard products, this disadvantage is made up for by the low thickness, since one of the components of the rigidity is the thickness to the power of 3.

By way of the form and depth of the embossing, moreover, it is possible to exert a positive influence on the conformability of the film when winding cables. In respect of telescoping as well, the embossing of the film has a positive influence, since under tension it is primarily the air enclosed between film and adhesive which is squeezed out.

Raw materials which can be used for the film include, for example, suspension-PVC powders having a K value of 60; in the case of low K values, the addition of impact modifiers (based for example on polyacrylate powders) is advisable.

On account of the greater thermal stability, however, a PVC with a high K value is preferred: for example emulsion-PVC of K value 78. Materials of this kind and their processing are described, for example, in Handbook of PVC Formulating, edited by E. J. Wickson, J. Wiley & Sons, 1993 or PVC: Production, Properties and Uses, G. Matthews, The Institute of Materials, 1996.

The K value of the film ought preferably to be situated at from 60 to 90, in particular from 75 to 80.

The addition of stabilizers such as diphenylthiourea, for example, is necessary in order to prevent thermal damage (for example, embrittlement) to the PVC films in the course of processing and during use as an adhesive tape. Such stabilizers are described, for example, in “Plastics Additives Handbook” (5th ed.), Hanser Verlag, chapter 3 and “Kunststoff-Handbuch—Polyvinylchlorid 2/1” (2nd) Hanser Verlag section 6.3. Stabilizers based on tin compounds in particular are suitable for the adhesive tape of the invention, preferably those approved for food packaging films such as dibutyltin bis(2-ethylhexylmercaptoacetate). The use of lead or cadmium stabilizers is likewise possible, though they are less favorably used on environmental and toxicological grounds. The stabilizer content is for example from 0.3 to 10 parts by weight per 100 parts by weight of PVC polymer; for the purpose of achieving high heat stability it is at least 0.7 and preferably at least 1 phr (parts by weight per 100 parts by weight PVC).

Further customary additives to PVC films, such as fillers, pigments, impact modifiers or lubricants and processing auxiliaries (for example, Paraloid K 120 ND, Rohm & Haas), may be used for producing the carrier film of the adhesive tape of the invention. Customary additives are described in “Kunststoff-Handbuch—Polyvinylchlorid 2/1” (2nd) Hanser Verlag chapter 6. A preferred lubricant used is montan ester wax, a favorable amount being from 2 to 5 parts by weight per 100 parts by weight of PVC polymer.

The carrier film is preferably produced on a calender by the high-temperature or low-temperature process, in particular with downstream stretching. The film is stretched by a multiple on a roller section at above 95° C., by means of increasing roller speeds, with a corresponding decrease in thickness. In addition, the film may also be pulled widthways to some extent (KOBRA™ process). The Luvitherm™ process is especially suitable for the adhesive tapes of the invention, since here even high K values can be processed without problems. It is also possible to process unplasticized PVC to thin films in a blowing process, although this process is suitable only for relatively low K values. The processes are described, for example, in “PVC: Production, Properties and Uses”, G. Matthews, The Institute of Materials, 1996 or “Kunststoffhandbuch”, edited by Hans K. Felger, volume 2 (Polyvinyl chloride), Hanser Verlag, 1986.

A film with embossing comprising continuous or interrupted lines extending longitudinally or transversely is preferred. Embossing of the film is sensible for the reasons set out above; in particular, it allows a reduced unwind force to be achieved, which has positive consequences for the customary processing of the adhesive tape by hand. The embossed depth, in other words the difference between the thickness calculated from the basis weight and the thickness determined using a thickness gage, is preferably in the range from 10 to 30 μm (for test methods see below).

The PVC carrier materials is provided on one side with an adhesive coating. Suitable pressure-sensitive adhesives include all common types, particularly adhesives based on rubber.

Such rubbers may be, for example, homopolymers or copolymers of isobutylene, of 1-butene, of vinyl acetate, of acrylates, of butadiene or of isoprene.

Particular interest attaches to formulas based on acrylates, butadiene or isoprene.

In order to optimize its properties the self-adhesive composition employed (adhesive) may be blended with one or more additives such as tackifiers (resins), plasticizers, fillers, pigments, UV absorbers, light stabilizers, aging inhibitors, photoinitiators, crosslinking agents or crosslinking promoters. Tackifiers are, for example, hydrocarbon resins (synthesized for example from unsaturated C5 or C7 monomers), terpene-phenolic resins, terpene resins obtained from raw materials such as α- or β-pinene, aromatic resins such as coumarone-indene resins or resins comprising styrene or α-methylstyrene, such as rosin and its downstream products such as disproportionated, dimerized or esterified resins, the use of glycols, glycerol or pentaerythritol being possible, and also further resins (as listed, for example, in Ullmanns Enzyklopädie der technischen Chemie, volume 12, pages 525 to 555 (4th ed.), Weinheim).

Examples of suitable fillers and pigments are carbon black, titanium dioxide, calcium carbonate, zinc carbonate, zinc oxide, silicates or silica. Examples of suitable admixable plasticizers are aliphatic, cycloaliphatic, and aromatic mineral oils, diesters or polyesters of phthalic acid, trimellitic acid or adipic acid, liquid rubbers (for example, nitrile or polyisoprene rubbers), liquid polymers of butene and/or isobutene, acrylates, polyvinyl ethers, liquid resins and plasticizer resins based on the raw materials for tackifier resins, lanolin and other waxes, or liquid silicones. Examples of crosslinking agents include isocyanates, phenolic resins or halogenated phenolic resins, melamine resins and formaldehyde resins. Examples of suitable crosslinking promoters include maleimides, allyl esters such as triallyl cyanurate, and polyfunctional esters of acrylic acid and methacrylic acid. Examples of aging inhibitors are sterically hindered phenols, which are known, for example, under the trade name Irganox™.

The application rate of the adhesive is preferably from 10 to 40 and in particular from 18 to 28 g/m².

Crosslinking is advantageous since it raises the holding power and so reduces the tendency for the rolls to deform on storage (telescoping or formation of voids, also called gaps). It also reduces the squeezing-out of the adhesive; this reduction is manifested in nontacky roll side edges and nontacky edges of adhesive tape wound spirally around cables. The holding power is also determined by the composition of the adhesive and by the plasticizer content of the film; it is preferably above 150 min.

The bond strength to steel should be in the range from 1.5 to 3 N/cm and the unwind force should be in the range from 3 to 6 N/cm. Where appropriate, a coating can be applied to the reverse face in order to adjust the unwind force. It is advantageous to use a primer layer between carrier film and adhesive in order to improve the adhesion of the adhesive to the film and hence to avoid transfer of adhesive to the reverse of the film during the unwinding of the rolls. Descriptions of the adhesives normally used for adhesive tapes, and also of release varnishes and primers, can be found, for example, in “Handbook of Pressure Sensitive Adhesive Technology”, D. Satas (3rd edition).

As primers it is possible to use the known dispersion and solvent systems, based for example on isoprene or butadiene rubber, cyclized rubber, and especially nitrile rubber. Isocyanate additives enhance the adhesion and shear strength of the adhesive following inward diffusion.

A release effect may be a result of application of known release agents (blended where appropriate with other polymers). Examples are stearyl compounds (for example, polyvinyl stearylcarbamate, stearyl compounds of transition metals such as Cr or Zr, ureas formed from polyethyleneimine and stearyl isocyanate, polysiloxanes (for example, as a copolymer with polyurethanes or as a graft copolymer onto polyolefin, and thermoplastic fluoropolymers). The term stearyl stands as a synonym for all linear or branched alkyls or alkenyls having a carbon number of at least 10, such as octadecyl, for example.

In summarizing, in another preferred embodiment, the adhesive is a self-adhesive composition based on polyisoprene, polyisobutylene and/or polyacrylate and is optionally provided with a primer.

Furthermore, it has turned out to be particularly advantageous if

the bond strength is in the range from 1.5 to 3.0 N/cm and/or

the unwind force is in the range from 3 to 6 N/cm and/or

the holding power is >150 min.

In order to obtain good hand tearability, rough cut edges are produced during production of the adhesive tape rolls; when such edges are viewed microscopically, the formation of cracks is observed which promote tear propagation. This is possible in particular through the use of a squeeze cutter with rotating blades which are blunt-ended or have a defined jaggedness, or by a slicing cutter with blunt-ended fixed blades. In view of the low thickness and minimal tendency toward telescoping, roll lengths of from 33 to 100 m are readily possible, whereas conventional products normally have comparatively low lengths of only 10 to 33 m.

According to UL 94, in the case of vertical samples, plasticized PVC adhesive tapes are not self-extinguishing, instead varying in their flame spread rate. The adhesive tapes of the invention are non-flammable, of low flammability, or at least self-extinguishing within a few seconds. Generally, therefore, they do not require the addition of flame retardants such as antimony oxide.

The adhesive tape is therefore preferably self-extinguishing.

The mechanical properties of the adhesive tape of the invention are situated preferably within the following ranges:

elongation at break in md (machine direction) less than 100%.

elongation at break in md at least 30% lower than in cd (cross direction)

tensile strength in md greater than 30 N/cm

force in md at 10% elongation greater than 15 N/cm

tensile impact strength of the film in cd less than 1000 kJ/m²

In one outstanding embodiment of the invention, moreover the adhesive tape has a heat stability of at least 85° C. and/or an elongation at break in md of less than 100%.

The particular mechanical properties make it possible to perceive the special features of the adhesive tape such as freedom from plasticizer and stretching (including the higher stretch in md than in cd).

The adhesive masking tape of the invention is preferably colored, especially black. The coloring can be introduced into the film, into the adhesive layer and/or into the primer layer or else by printing of the film before, during or after its coating with adhesive.

The outstanding configuration of the adhesive tape of the invention ensures its suitability particularly for insulating and winding wires or cables.

Moreover, the adhesive tape can also be used to excellent effect for wrapping elongate material, such as cable harnesses in vehicles in particular, very particularly automobiles.

### Test Methods

The measurements are made under test conditions of 23±1° C. and 50±5% relative humidity.

The tensile elongation behavior of the adhesive masking tape is measured on type 2 test specimens (where possible): test strips 15 mm wide and 150 cm long, clamped length 100 mm, in accordance with DIN EN ISO 527-3/21300, at a testing speed of 300 mm/min. In the case of samples with rough cut edges, the edges must be tidied up with a sharp blade prior to the tensile test.

The tensile impact strength of the adhesive tape is determined in accordance with DIN EN ISO 8256 on samples measuring (where possible) 15 mm in width and 27 mm in length.

In the case of the cd tensile impact strength, the test specimens are cut perpendicular to the machine direction and the course of the tear is therefore longitudinal with respect to the machine direction. In each case, the arithmetic mean of 10 measurements is stated. In accordance with DIN EN ISO 8256, the tensile impact strength is given by the following calculation:

E=E_{c}/(x*d)*1000 i.

where

1. E is tensile impact strength

2. E_{c} is impact energy

3. x is sample width

4. d is sample thickness.

The bond strengths are determined at a peel angle of 180° in accordance with AFERA 4001 on strips 15 mm wide (where possible). The test substrates used here are steel plates in accordance with the AFERA standard.

The thickness is determined in accordance with DIN 53370, with the gage being planar (not curved). In the case of textured films, however, it is the thickness before embossing which is taken as the basis. This can also be done subsequently via the weight per unit area (determined in accordance with DIN 53352) with conversion using the density (PVC=1.37 g/cm³). The embossed depth is the difference between the thicknesses with and without embossing.

The determination of PVC polymer K values is governed by DIN 53726/ISO 174.

The holding power is determined in accordance with PSTC 107 (10/2001), the weight being 20 N and the dimensions of the bond area being 20 mm in height and 13 mm in width.

The unwind force is determined at 30 m/min in accordance with DIN EN 1944.

The fire behavior is measured in accordance with UL 94 on a vertical sample.

The heat stability is determined in accordance with Ford specification S96GG-14K024-M after 3000 hours in an oven in accordance with ASTM D 573.

The following examples are intended to illustrate the invention without restricting its scope.

### EXAMPLE 1

The example was prepared using Genotherm GE 15 black 35 μm from Kalle, Weert, NL. The film is composed of suspension-PVC which is said to have a K value of 60 and comprises a tin stabilizer, an impact modifier (from Kaneka), and also lubricants and carbon black pigment.

This carrier film is coated with a layer of adhesion promoter consisting of a solution of 1 part natural rubber and 1 part nitrile rubber in toluene, at an application rate of 0.6 g/m², and dried. The adhesive is applied directly to the adhesion promoter layer, using a comma bar, at an application rate of 25 g/m² (based on dry matter).

The adhesive comprises a solution of a natural rubber adhesive in petroleum spirit with a solids content of 30 percent by weight. Said natural rubber adhesive is composed of 50 parts natural rubber, 10 parts zinc oxide, 3 parts rosin, 6 parts alkylphenol resin, 17 parts terpene-phenolic resin, 12 parts poly-β-pinene resin, 1 part Irganox™ 1076 antioxidant, and 2 parts mineral oil. The coating is dried in a drying tunnel at 70° C.

The adhesive tape is then wound to coils of a length of 33 m. For slitting, the coils are sliced by means of a fixed blade (straight knife).

### EXAMPLE 2

The invention is implemented as in Example 1, with the following modifications.

The carrier film used is R240 film (formerly GA 06) from Klöckner-Pentaplast, Gendorf. It carries 441 embossing and has a pre-embossing thickness of 30 μm, and is colorless. It contains E-PVC with a K value of 78, about 0.6% by weight tin stabilizer (by analysis Mark 17 M from Crompton Vinyl Additives GmbH) and about 3% montan ester wax. The film was produced by the Luvitherm™ process.

The underside is provided with 1 g/m² of a primer comprising natural rubber, cyclized rubber, carbon black and 4,4′-diisocyanatodiphenylmethane.

The adhesive is prepared in hexane in a kneading apparatus from 40%. by weight natural rubber SMRL, 10% by weight of titanium dioxide, 37% by weight of a C5 hydrocarbon resin having an R&B value of 95° C. and 1% by weight of Vulkanox™ BKF (Bayer) antioxidant. The 20% by weight adhesive is applied to the primed underside of the film at 23 g/m² (based on dry matter) using a coating bar and dried at 115° C. The adhesive tape is then wound up to jumbos (large rolls) which are processed by a squeeze cutter to give rolls 66 m long.

### EXAMPLE 3

The invention is implemented as in Example 1, with the following modifications.

The film is Genotherm GE 15 colorless 25 μm from Kalle, Weert, NL and is analogous in its construction to the film from Example 1.

On one side the film was printed with a printing ink from Huber; the ink was noted to comprise vinyl chloride-vinyl acetate copolymer, carbon black, and butanone as ingredients.

The other side was coated with 1 g/m² Desmolac™ 4125 (Bayer) as a primer for the adhesive, and applied to the primer was Rikidyne BDF 505 (solvent-based acrylic composition from Vig te Qnos) crosslinked with 1% by weight Desmodur Z 4470 MPA/X (isocyanate from Bayer) per 100 parts by weight of adhesive (calculated based on dry content) at 23 g/m² (based on dry matter).

Slitting is performed by slicing coils with a length of 33 m using rotating blades (round blade).

### COMPARATIVE EXAMPLE 1

For coating, a conventional film for insulating tape from Singapore Plastic Products Pte. bearing the designation F2104S was used. The film contains 100 phr (parts per hundred resin) of suspension-PVC of K value 65, 45 phr of DOP (plasticizer), 5 phr of tribasic lead sulfate (TLB, stabilizer), 20 phr of chalk (filler, quality ground chalk from Bukit Batu Murah Malaysia with fatty acid coating), 2 phr carbon black (black pigment) and 0.2 phr stearic acid (lubricant). The nominal thickness is 100 μm and the surface is smooth but matt.

Applied to one side is the primer Y01 from Four Pillars Enterprises, Taiwan (acrylate-modified SBR rubber in toluene) and atop it 23 g/m² of the adhesive IV9 from Four Pillars Enterprises, Taiwan (main components: SBR and natural rubber, terpene resin and alkylphenol resin in toluene). Slitting is accomplished by slicing coils with a length of 33 m using rotating blades (round blade).

Comparison of properties

| | | | | | | Comparative |
|---|---|---|---|---|---|---|
| | | | Example 1 | Example 2 | Example 3 | Example 1 |
| Film thickness | | [μm] | 35 | 30 | 25 | 100 |
| Thickness from basis weight | | [μm] | 34 | 46 | 25 | 102 |
| Tensile strength | md* | [N/cm] | 59 | 51 | 44 | 15 |
| Tensile strength | cd* | [N/cm] | 19 | 18 | 13 | 14 |
| Elongation at break | md* | [%] | 65 | 75 | 70 | 150 |
| Elongation at break | cd* | [%] | 190 | 230 | 150 | 160 |
| Force at 10% | md* | [N/cm] | 29 | 24 | 20 | 8 |
| Hand tearability | | | good | very good | very good | difficult |
| Tensile impact strength | cd* | [kJ/m²] | 250 | 100 | not tested | 1700 |
| Bond strength, steel | | [N/cm] | 2.4 | 2.0 | 2.4 | 1.8 |
| Holding power | | [min] | 1500 | 350 | >2000 | <1 |
| Unwind force 30 m/min | | [N/cm] | 5.0 | 3.5 | 4.6 | 6.4 |
| Heat stability 85° C. | | | film slightly | perfect | perfect | perfect |
| | | | embrittled | | | |
| Heat stability 105° C. | | | film | perfect | perfect | film embrittled |
| | | | embrittled | | | |
| Fire behavior | | | not | not | self- | burns with very |
| | | | combustible | combustible | extinguishing | sooty flame |
| | | | | | after 1 sec | |

*md-in machine direction: cd-transverse to the machine direction (cross direction)

What is claimed is:

1. An adhesive tape for insulating and winding wires or cables, comprising a carrier material which is coated on one or both sides with an adhesive, wherein said carrier material is composed of a PVC film in web form having a thickness of up to 40 μm, and is substantially plasticizer-free.

2. The tape as claimed in claim 1, wherein the PVC film is stretched and/or has a thickness of from 20-40 μm.

3. The tape as claimed in claim 1, wherein the PVC film has a thickness of from 25 to 30 μm and/or a K value of from 60 to 90.

4. The tape as claimed in claim 3, wherein the PVC film has a K value of from 75 to 80.

5. The tape as claimed in claim 1, wherein the PVC film is embossed.

6. The tape as claimed in claim 5, wherein the embossing is from 10 to 30 μm deep and/or the embossing comprises a pattern with continuous or interrupted lines extending longitudinally or transversely.

7. The tape as claimed in claim 1, wherein the PVC film is stabilized with at least 0.7 phr of a tin compound.

8. The tape as claimed in claim 1, wherein the adhesive is a self-adhesive composition based on polyisoprene, polyisobutylene and/or polyacrylate and is optionally provided with a primer.

9. The adhesive tape as claimed in claim 1, wherein the bond strength is in the range from 1.5 to 3.0 N/cm and/or the unwind force is in the range from 3 to 6 N/cm and/or the holding power is >150 min.

10. The tape as claimed in claim 1, which has a rough cut edge.

11. The tape as claimed in claim 1, which is self-extinguishing, colored and/or black.

12. The tape as claimed in claim 1, which has a heat stability of at least 85° C. and/or an elongation at break in md (machine direction) of less than 100%.

13. The tape as claimed in claim 1, which exhibits a force in md at 10% elongation greater than 15 N/cm and/or a tensile impact strength below 1000 kJ/m².

14. A method for insulating and winding wires or cables comprising insulating and winding said wires or cables with an adhesive tape according to claim 1.

15. A method for wrapping elongate material comprising wrapping said elongate material with an adhesive tape according to claim 1.

16. The method according to claim 15, wherein said elongate material comprises a cable harness in a vehicle.

17. The method according to claim 16, wherein said vehicle is an automobile.
